(19) United States
(12) Patent Application Publication
(10) Pub. No.: US 2016/0229645 A1
(43) Pub. Date: Aug. 11, 2016

(54) TRANSFER DEVICE

(71) Applicant: ROBERT BOSCH GMBH, Stuttgart (DE)

(72) Inventors: Philipp Markus Von Ehrenstein, Dresden (DE); Sebastian Gran, Heuchelheim (DE); Markus Hanisch, Fellbach (DE); Bernd Wilke, Leutenbach (DE); Joshua Windsheimer, Satteldorf (DE); Philipp Kathan, Schaffhausen (CH)

(21) Appl. No.: 14/914,885

(22) PCT Filed: Jul. 28, 2014
(86) PCT No.: PCT/EP2014/066138

§ 371 Date: Feb. 26, 2016

(30) Foreign Application Priority Data
Aug. 26, 2013 (DE) 102013216958.2

(51) Int. Cl. B65G 54/02

(52) U.S. Cl. CPC B65G 54/02

(57) ABSTRACT

The invention relates to a transfer device comprising a moveable element (2), a stationary guide rail (3), and a linear in motor drive device (4) for driving the moveable element (2). Said moveable element (2) comprises support elements (5) which can be brought into contact with the guide rail (3), and at least one of the support elements has a contact area which is arranged at an angle (α) not equal to 90° to a vertical axis (H) of the moveable element (2) and at an angle (β) not equal to 90° to a transverse axis (Q) of the moveable element (2).

### BACKGROUND OF THE INVENTION

The invention relates to a transfer device, in particular for a product transport, for example a product transport to a packaging machine.

Transfer systems are known in different configurations. The German patent publication DE 10 2011 003 178 A1 discloses, for example, a transfer system, in which a movable conveyor element can be moved on a stationary circulating guide rail by means of a linear motor drive device. This device has proven successful; however, a slippage can occur between the movable conveyor element and the guide rail when traveling around curves. Particularly increased wear to the conveyor elements and or the guide rail can also occur in the curves. A transport device is further known from the German patent publication DE 10 2010 027 925 A1 which has an articulated conveyor element. Especially problems occurring when traveling around curves can be solved by means of the articulated conveyor element. The articulated conveyor elements are, however, relatively expensive and complicated to produce. It would therefore be desirable to have a simply constructed transfer system, which does not show wear particularly in the curves.

### SUMMARY OF THE INVENTION

The transfer device according to the invention has on the other hand the advantage that significantly less wear occurs to an articulated element as well as to a stationary guide rail even in curves of the transfer system. According to the invention, even very tight curves as well as counter curves can, in particular, be provided by means of the guide rail without an excessive sliding or slipping of the articulated element thereby occurring. This is achieved according to the invention by virtue of the fact that the transfer device comprises a movable element, a stationary guide rail and a linear motor drive device for driving the movable element. Said movable element comprises support elements. The support elements can be brought into contact with the guide rail, preferably with running surfaces provided on the guide rail. In so doing, at least one of the support elements has a contact surface which is arranged at an angle not equal to 90° to a vertical axis as well as to a transverse angle of the movable element. According to the invention, the contact surfaces of the support elements are therefore arranged at an angle not equal to a right angle to a vertical axis and to a transverse angle of the movable element, whereby the undesirable sliding or slipping or the like can be minimized even when negotiating curves in the transfer system. The running surfaces are arranged on the guide rail in accordance with the angle of the contact areas of the support elements. The contact areas of the support elements can be line regions, e.g., if the support elements are rollers or surface areas, e.g., if the support elements are sliding elements.

The movable element is preferably designed as a single member. The element can also be designed having a plurality of members.

The angle of the contact area to a vertical axis and to a transverse axis is preferably in a range of 30° to 60°, preferably approximately 45°. As a result, very tight curves and counter curves can be traversed without slippage.

In a particularly preferred manner, all contact areas of the support elements are arranged at an angle not equal to 90° to a vertical axis and to a transverse axis. This action prevents individual support elements that are not arranged according to the invention from possibly sliding when traveling around a curve and thus wear, abrasion or something similar from occurring.

In a particularly preferred manner, the support elements are spring-mounted. The resilient mounting provides an improved running smoothness of the movable element on the guide rail. The resiliently arranged support elements can furthermore better traverse curves, wherein the resilient support elements particularly allow for a faster traversing of curves. If need be, the support elements namely deflect when there is strong contact with the guide rail and as a result prevent undesirable wear to the movable element. This leads to a minimization of force.

The support elements are preferably provided as rollers and/or sliding elements and/or levitation elements, i.e. freely floating elements.

At least two support elements are furthermore preferably provided, the two support elements being arranged at different angles unequal to 90° to a vertical axis and transverse axis.

The transfer device preferably comprises a carrier frame having an opening which enables an open, not circumferentially closed carrier frame to be provided.

In a particularly preferred manner, the carrier frame is formed from a composite material comprising an outer casing and a core, wherein the carrier frame has damping properties. The carrier frame particularly has damping properties resulting from the selection of the material of the core. For example, the material of the core is aluminum and the casing of the carrier frame consists of a plastic reinforced with carbon fibers.

In a further preferred manner, the open side of the carrier frame is preferably on a side oriented towards the guide rail. In so doing, the movable element can, e.g., sit on the guide rail or hang on the same. The shape of the open carrier frame preferably corresponds to an inversely arranged U or V, or a T, or an X, or a Y, or a slotted O.

It is furthermore preferred for the movable element be configured symmetrically to the vertical axis. In a further preferred manner, permanent magnets are arranged on the movable element, which magnets are disposed on the carrier frame on a side oriented towards the guide rail. The permanent magnets are thereby part of the linear motor drive device, wherein an energizable coil is disposed in the guide rail. The permanent magnets are preferably disposed on the carrier frame in the region of the opening

A center of rotation of the movable element is preferably disposed in the region of the permanent magnets in order to ensure a particularly quiet running of said movable element.

The permanent magnets are preferably disposed on the carrier frame of the movable element by means of retainers or something similar. It is also further preferred for the support elements of the movable element to be disposed on the carrier frame by means of retainers. As a result, a standard carrier frame can be used by the selection of different retainers; and the different retainers facilitate in each case a corresponding adaptation to different guide rails. The retainers are preferably intended to be replaceable.

In a particularly preferred manner, the linear motor drive device comprises a plurality of drives. The multiple drives are preferably disposed parallel to one another. The multiple drives are alternatively disposed at an angle to one another. The guide rail furthermore preferably comprises a switch point. The switch point is preferably designed as a linear switch point which is switched from a first guide rail to a second guide rail by means of a parallel shift of a guide rail section. The guide rail alternatively comprises a rotary switch point, wherein a guide rail is rotatably mounted and is adjusted from a first guide rail to a second guide rail by means of rotation.

### BRIEF DESCRIPTION OF THE DRAWINGS

Preferred exemplary embodiments of the invention are described below in detail with reference to the accompanying drawings. In the drawings:

FIG. 1 shows a schematic, partially cutaway view of a transfer device according to one exemplary embodiment of the invention;

FIG. 2 shows a schematic, perspective view of a movable element of the transfer device of FIG. 1; and

FIGS. 3-10 show further preferred exemplary embodiments of the invention.

### DETAILED DESCRIPTION

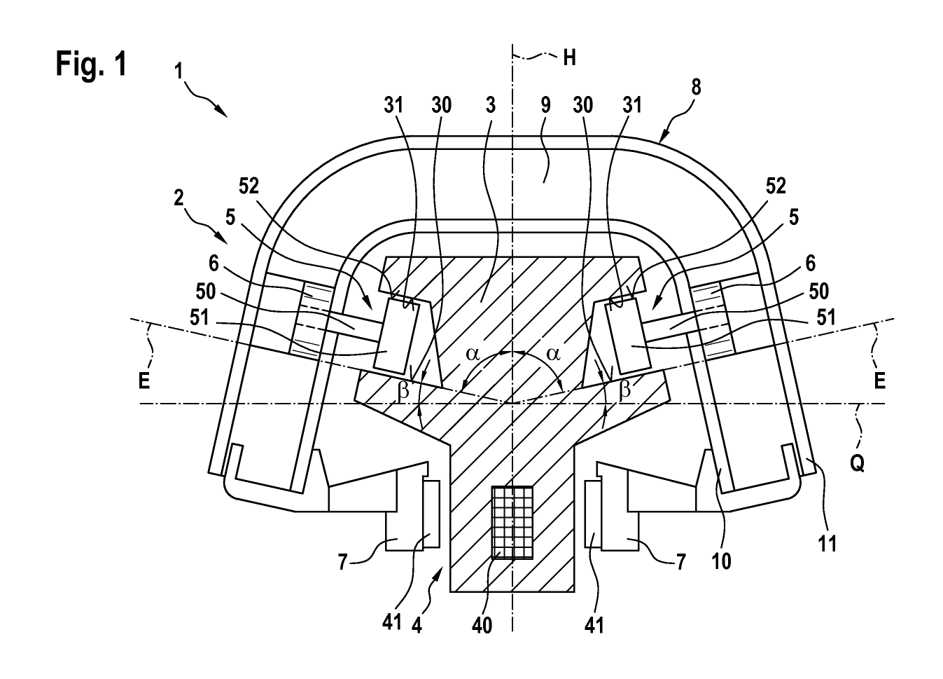

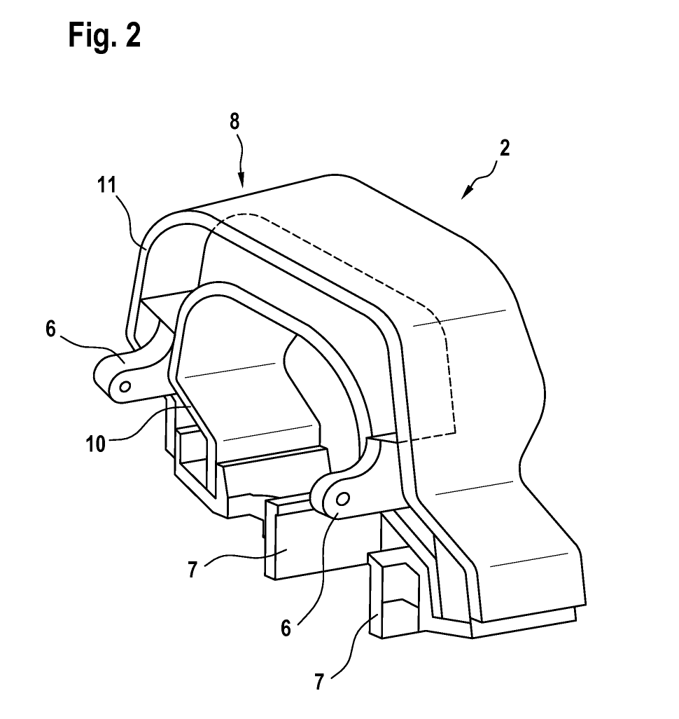

A transfer device 1 according to a preferred exemplary embodiment of the invention is described below in detail with reference to FIGS. 1 and 2.

As can be seen in FIG. 1, the transfer device 1 according to the invention comprises at least one movable element 2 which can be moved on a guide rail 3. The guide rail 3 can be a circumferentially closed guide rail or also alternatively a linear guide rail. A plurality of movable elements 2, which each can be individually actuated, is preferably arranged on the guide rail 3. Such transfer devices are, for example, used to supply and discharge products from machines, in particular packaging machines.

The transfer device 1 further comprises a linear motor drive device 4, which comprises a coil 40 integrated into the stationary guide rail 3 as well as permanent magnets 41, the permanent magnets 41 being disposed on the movable element 2.

Running surfaces 30, 31 are further provided on the guide rail 3.

In addition, the movable element comprises an open carrier frame 8. The carrier frame 8 comprises a core 9 as well as an inner casing 10 and an outer casing 11. The core 9 is preferably manufactured from aluminum, and the two casings are preferably manufactured from a carbon composite material. The carrier frame 8 is open at a lower end and has in the cross section thereof an upside down substantially U-shape. As a result, the movable element 2 sits on the guide rail 3.

As can be seen in FIG. 1, the permanent magnets 41 are arranged at the opening of the carrier frame 8.

The movable element 2 further comprises support elements 5. In this exemplary embodiment, the movable element comprises exactly two support elements. The support elements of this exemplary embodiment each comprise a shaft 50 on the free end of which respectively one roller 51 is disposed. The rollers 51 have running surfaces 52 on the outer circumference thereof. The support elements 5 are fastened by means of first retainers 6 to the carrier frame 8 of the movable element (cf. FIG. 2).

The movable element 2 further has a vertical axis H and a transverse axis Q. The vertical axis H is perpendicular to the transverse axis Q.

A contact area of the support element 5 is therefore provided by the running surface 52 of the rollers 51. A contact line thus results when contact is made with the running surfaces 30, 31. The contact line lies in a plane E which is disposed at an angle α not equal to 90° to the vertical axis H and an angle β unequal to 90° to the transverse axis Q. As a result of this inclined arrangement of the support element relative to the vertical axis H and the transverse axis Q, it is now possible for the movable element 2 to also travel around tight curves of the guide rail 3 without sliding or slipping. According to the invention, it is thereby ensured that the rollers 51 do not or only minimally slide, but roll in every position on the running surfaces 30, 31. As a result, abrasion or wear to the support elements 5 as well as to the running surfaces on the guide rail 3, which occurs in the prior art to date, can be minimized.

In the exemplary embodiment depicted, the two support elements 5 are disposed respectively at the same angle α and β to the vertical axis H and to the transverse axis Q. It should be noted that the two support elements can also, however, alternatively be disposed at different angles, angles of 0° or 90° being however omitted according to the invention. In a particularly preferred manner, the angle α and the angle β are in a range between 30° and 60°, in particular at angle of approximately 45°.

It should be further noted that, if the movable element 2 has a plurality of support elements 5, individual support elements 5 can also in each case be disposed at different angles to the transverse axis Q and to the vertical axis H. Alternatively, some of the support elements can also be disposed at the same angles when a plurality of support elements are present.

If, for example, sliding elements are used instead of rollers 51, a linear contact no longer results between the sliding elements and the running surfaces 30, 31, but rather a planar contact, wherein a wear can then also be significantly reduced according to the invention.

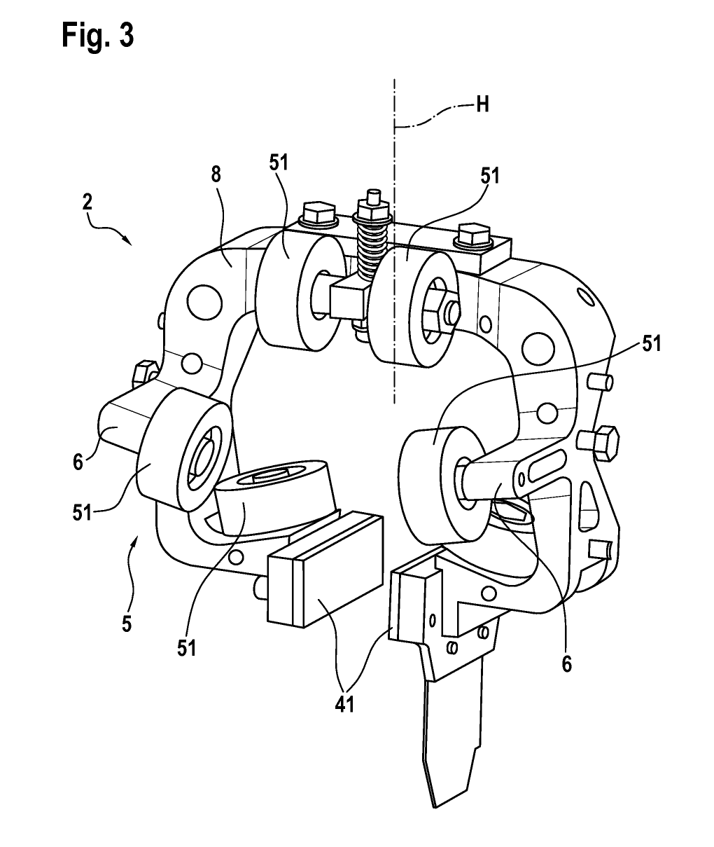

FIG. 3 shows a second exemplary embodiment in which the movable element 2 has exactly six rollers as support elements. In so doing, four rollers are disposed at an angle unequal to 90° to the vertical axis H and at an angle unequal to 90° to the transverse angle. Two rollers are disposed in the transition region of the U-shaped carrier frame 8.

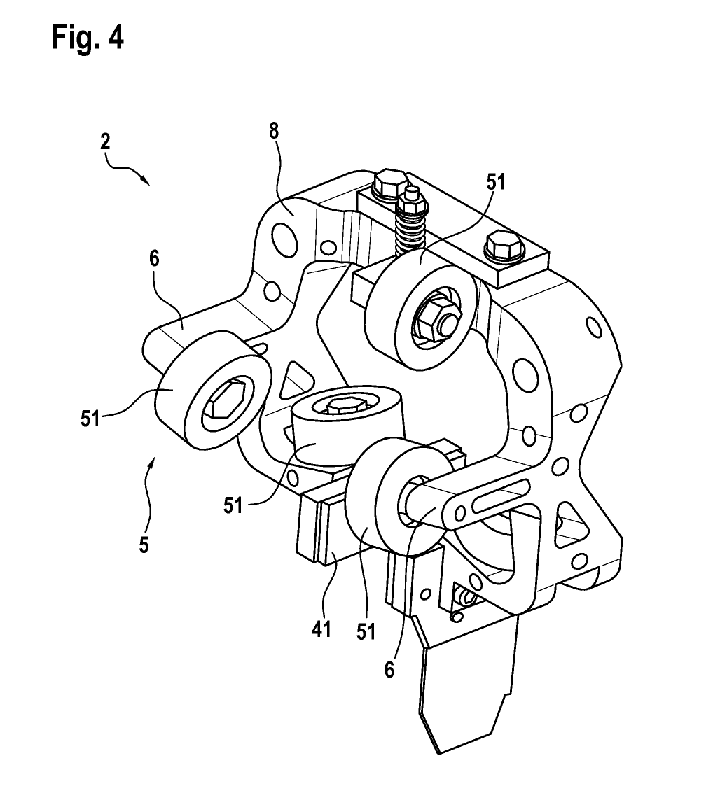

In the third exemplary embodiment of the invention depicted in FIG. 4, exactly five support elements 5 comprising rollers 51 are provided. Only one roller is disposed in the transition region of the U-shaped carrier framework 8 in this exemplary embodiment.

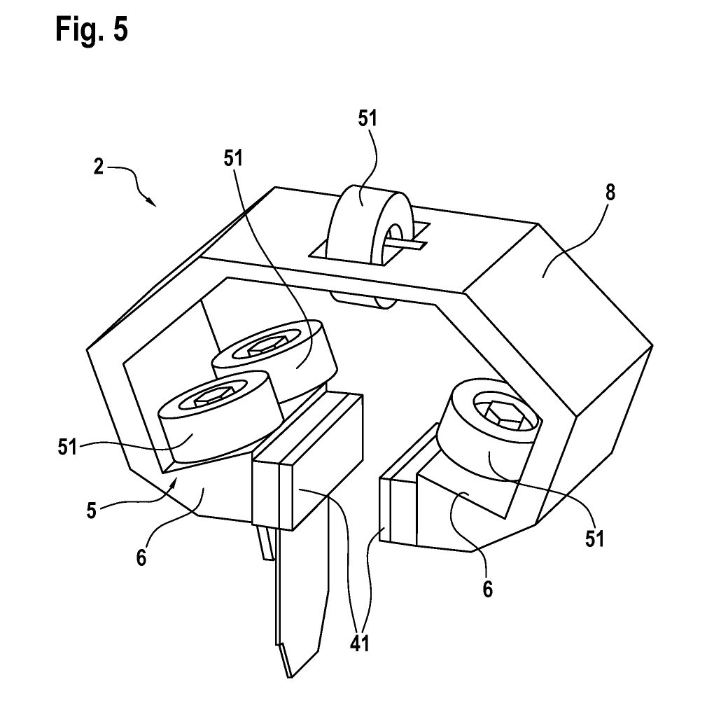

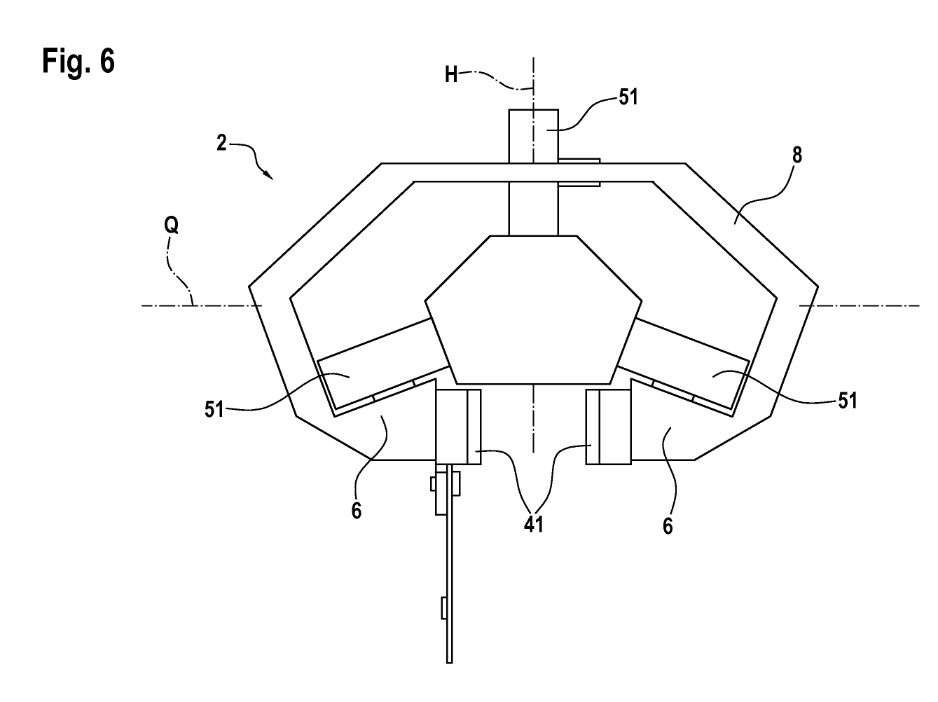

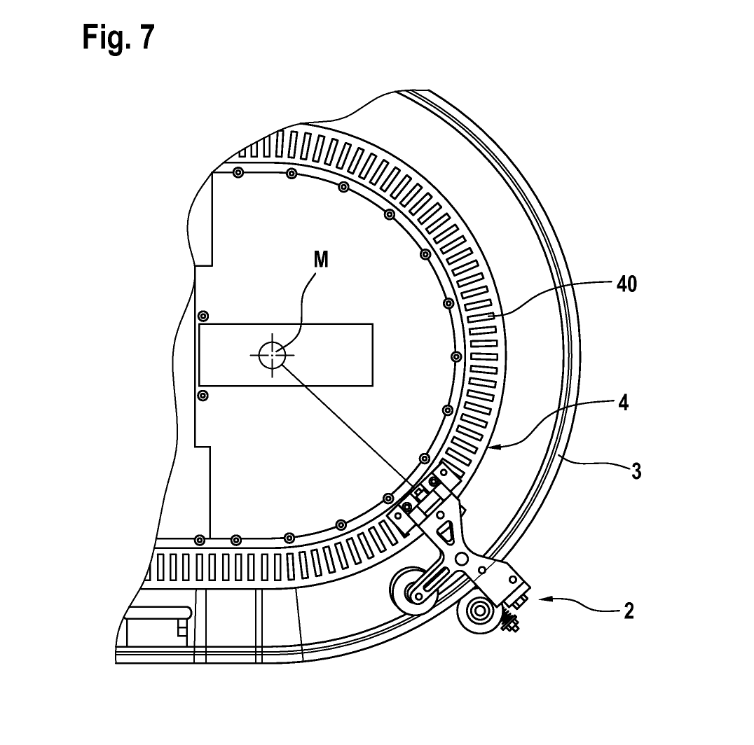

The FIGS. 5 to 7 show a fourth exemplary embodiment of the invention. In the fourth exemplary embodiment, the open carrier element 8 has an angular shaped design. In addition, the four support elements 5 are provided in the form of rollers 51. Three rollers 51 are thereby disposed at an angle unequal to 90° to the vertical axis H and at an angle unequal to 90° to the transverse axis Q. FIG. 7 shows the movable element 2 traversing a curve. The permanent magnets 41 are aligned with a central point of the curve M.

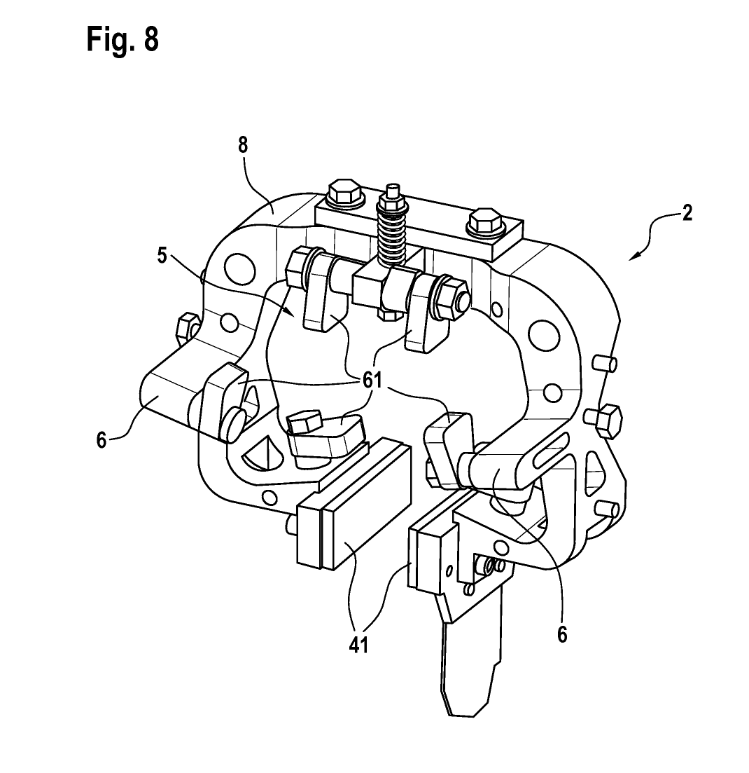

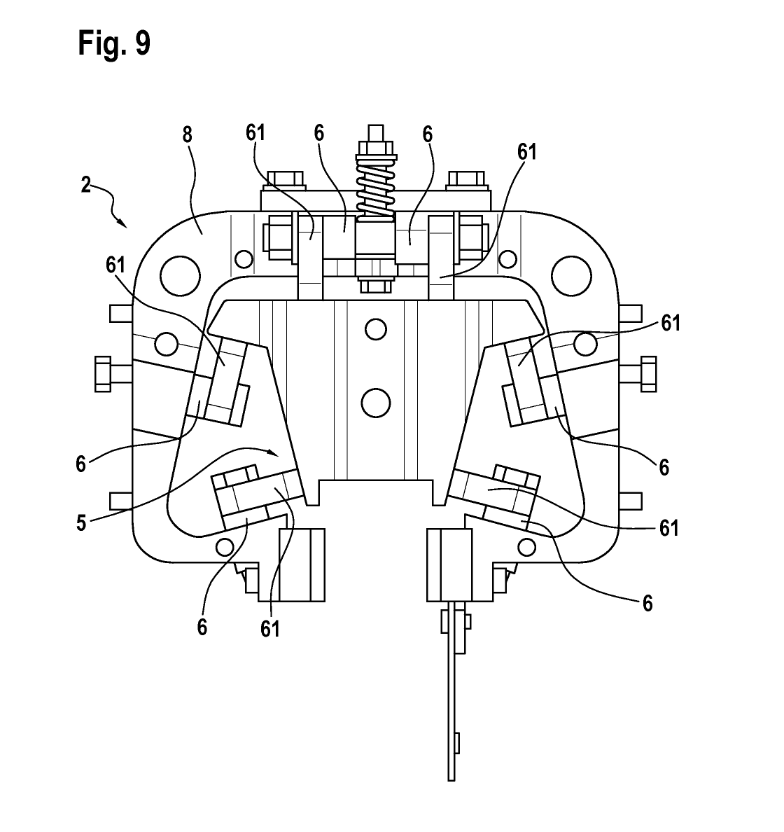

FIGS. 8 and 9 show a fifth exemplary embodiment of the invention, which substantially corresponds to the second exemplary embodiment of FIG. 3. The support elements 5 are provided in the form of sliding elements 61 instead of rollers. The sliding elements 61 slide on the guide track 3. In total, six sliding elements 61 are provided.

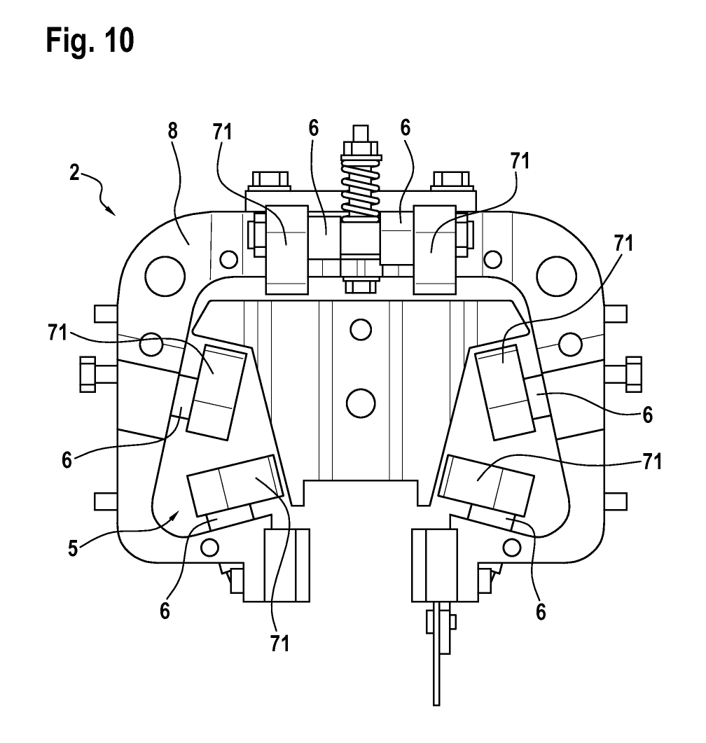

FIG. 10 shows a sixth exemplary embodiment of the invention, in which the support elements 5 are provided in the form of floating elements 71. As can be seen in FIG. 10, ten floating elements 71 are likewise provided. The arrangement of the floating elements 71 corresponds to the arrangement of the sliding elements in FIGS. 8 and 9 or, respectively, the rollers 51 in FIG. 3. The floating elements therefore prevent the guide track 3 from being touched so that no wear occurs at all. The floating elements 71 are designed in such a way that no damage occurs to the floating elements or to the guide rail even in the event of contact. The floating can, for example, be implemented by magnetic repulsion.

1. A transfer device, comprising:
a movable element (2),
a stationary guide rail (3), and
a linear motor drive device (4) for driving the movable element (2),
wherein the movable element (2) comprises support elements (5) configured to be brought into contact with the guide rail (3), and
wherein at least one of the support elements (5) has a contact area which is arranged at first angle (α) not equal to 90° to a vertical axis (H) of the movable element (2) and at a second angle (β) not equal to 90° to a transverse axis (Q) of the movable element (2).

2. The transfer device according to claim 1, characterized in that the movable element (2) is a single member.

3. The transfer device according to claim 1, characterized in that the first angle (α) lies in a range between 30° and 60°.

4. The transfer device according to claim 1, characterized in that all support elements (5) have a contact area which is arranged at an angle not equal to 90° to the vertical axis (H) and not equal to 90° to the transverse axis (Q).

5. The transfer device according to claim 1, characterized in that the support elements (5) are resiliently mounted.

6. The transfer device according to claim 1, characterized in the support elements (5) are one or more of the following: rollers (51); sliding elements and levitation elements.

7. The transfer device according to claim 1, characterized in that at least two support elements (5) are arranged at a different angle to the vertical axis (H) and to the transverse axis (Q).

8. The transfer device according to claim 1, characterized in that the movable element (2) comprises an open carrier frame (8), which has an opening on at least one side.

9. The transfer device according to claim 8, characterized in that the open carrier frame (8) comprises a core (9), an inner casing (10) and an outer casing (11).

10. The transfer device according to claim 8, characterized in that the movable element (2) comprises permanent magnets (41) of the linear motor drive device (4) which are disposed on the carrier frame (8) at the opening of said carrier frame.

11. The transfer device according to claim 10, characterized in that a center of rotation of the movable element lies in a region between the permanent magnets (41).

12. The transfer device according to claim 1, characterized in that the support elements (5) are disposed on the movable element (2) by means of retainers (6, 7).

13. The transfer device according to claim 1, characterized in that the first angle (α) is approximately 45°.

14. The transfer device according to claim 8, characterized in that the open carrier frame (8) comprises a core (9), an inner casing (10) and an outer casing (11), wherein the core (9) is an aluminum core and the inner and outer casing consist of a carbon reinforced plastic.

15. The transfer device according to claim 12, characterized in that the permanent magnets (41) are disposed on the movable element (2) by means of retainers (6, 7).

16. The transfer device according to claim 1, characterized in that the permanent magnets (41) are disposed on the movable element (2) by means of retainers (6, 7).
